(19) United States
(12) Patent Application Publication
(10) Pub. No.: US 2016/0108943 A1
(43) Pub. Date: Apr. 21, 2016

(54) INCREMENTAL ADJUSTMENT TOOL

(71) Applicant: Curtis Knutson, Loves Park, IL (US)

(72) Inventor: Curtis Knutson, Loves Park, IL (US)

(21) Appl. No.: 14/887,692

(22) Filed: Oct. 20, 2015

Related U.S. Application Data
(60) Provisional application No. 62/066,857, filed on Oct. 21, 2014.

(51) Int. Cl. F16B 5/02

(52) U.S. Cl. CPC F16B 5/0225

(57) ABSTRACT

An incremental adjustment tool for being placed between two objects and used to position the first object along the second object in extremely fine increments. The tool has first, second, and third plates arranged in a stack. The first plate includes a first set of teeth with constant spacing between them that interface with a similar second set of teeth on one side of the second plate. On an opposite surface of the second plate there is a third set of teeth with constant spacing between them different from the spacing of the first and second sets of teeth. The third set of teeth interfaces with a similar fourth set of teeth of equal spacing on the third plate. Movement of the first, second, and third plates along one other displaces the first and second objects along one another. The first, second, and third plates can be parallel to one another or non-parallel, to accommodate corresponding orientations of the first and second objects.

### TECHNICAL FIELD

The present disclosure set forth herein relates generally to mechanical adjustment means, and more specifically to systems, methods, and modes for incrementally adjusting position of one object along a second object, using a precision mechanical adjustment device.

### BACKGROUND

In the art of mechanical devices, it is sometimes useful to provide not only gross positional adjustment mechanisms, but also “fine” or micro-adjustment mechanisms. That is, it is useful to be able to adjust the relative positions between at least two objects in regard to distances that are only tenths of an inch, hundredths of an inch, or even thousandths of an inch. It is known to be able to do that using screws and the like, but the problem with those devices is that it is difficult to know with certainty exactly how much a turn of the screw, regardless of how fine it is, will adjust the distance between two objects.

There have been those in the art of the aspects of the examples discussed below that have attempted different ways to make micro-adjustments on a repeated and known basis. U.S. Pat. No. 904,314 describes a mechanism for operating pumps and other like machinery, and is especially allegedly useful for actuating single, double acting or compound air pumps and light machinery. The mechanism includes piston rods 4 and 5 of pump cylinders 1 and 1′, respectively, and are provided with extensions constituting racks 6 and 7, the teeth of which face inwardly, toward each other. A base plate 8, which is suitably bolted or otherwise secured upon the foundation A, is provided with a keeper 9 constituting a guide or bearing for the rack bar 7. A stub axle or pintle 10, which projects from the supporting plate 8, carries a pinion or spur wheel 11 that meshes with the rack bars 6 and 7, which are thereby connected for simultaneous movement in opposite directions.

U.S. Pat. No. 1,779,985 describes a carton sealing apparatus, and shows opposed racks and intervening gear at the center of FIG. 3. U.S. Pat. No. 1,973,894 describes an extension table, with a mechanism that includes a gear 10 that engages slots 12. U.S. Pat. No. 4,207,051 describes An injection-molding machine has a fixed and a movable outer platen bracketing a movable intermediate platen, the latter having a runner system conducted via an extensible or flexible conduit to a source of molten plastic material to be injected into cavities defined by respective pairs of mold portions supported by the three platens, the cavities being formed in part by cores carried on the outer mold portions. The motion of the stripper plates is brought about by racks 27 and 28, ad pinion 30 (see, e.g., column 3, liens 8-27 and FIGS. 1.3 and 3).

U.S. Pat. No. 4,309,827 describes an adjustable sighting device for archery bows wherein various sighting screw units are employed, and as mounted to a suitable mount apart or attachable to a bow, can be made incrementally adjustable not only as to azimuth or windage, but also vertically. The screw adjustment mechanism is discussed at column 4, lines 31-43 and FIG. 4.

U.S. Pat. No. 4,487,047 describes a thin-wall spline forming apparatus (20) that includes toothed forming racks 24 having associated tooth pitch lines 48 and a toothed mandrel 22 having a tooth pitch circle 50 that is tangent to the forming rack pitch lines, and of a diameter equal to the mean diameter of thin-wall splines 44 formed by meshing the rack and mandrel teeth with a thin-wall sleeve 38 of a power transmission member mounted on the mandrel between the meshing teeth. A mandrel drive gear 60 drives the mandrel in coordination with the forming racks 24 and is driven by a pair of drive racks 62 mounted for movement with the forming racks. The '047 patent asserts that the best results are achieved when the mandrel 22 has the same number of teeth 40 as the number of teeth 64 of the drive gear 60 and with the mandrel and drive gear teeth aligned with each other.

U.S. Published Patent Application No. 2008/0256907 describes a film removal system for removing wrapped film from product cases in a packaging system. In FIGS. 24 and 25 are shown opposed toothed racks that include an intervening gear described in paragraph [0070]. German Patent No. 3,105,175 describes a gearwheel 12 that adjusts toothed racks 5 and 6 in opposite directions.

There are certain problems, however, with conventional mechanisms for adjusting relative positions of two or more objects. Accordingly, it would be desirable to provide methods, modes and systems for incrementally adjusting relative positions of two or more objects using a precision mechanical adjustment device.

### SUMMARY

An object of the present disclosure is to substantially solve at least the problems and/or disadvantages discussed above, and to provide at least one or more of the advantages described below.

According to a first aspect of the disclosure, an incremental adjustment tool for adjusting position of a first object along a second object is provided, that comprises three plates, with two sets of intermeshing teeth. According to one aspect of the disclosure, an incremental adjustment apparatus according to aspects of the examples can be placed between two objects, where it is desired to move the first object with respect to the second object. The three plates comprise an upper plate, middle plate, and lower plate. The upper plate has a set of teeth with a first substantially constant spacing between them that interface with a similar set of teeth of the first substantially constant spacing on the middle plate. On an opposite surface of the middle plate there is a second set of teeth with a second substantially constant spacing between them, that interface with a similar set of teeth of the second substantially constant spacing on a lower plate. Tooth spacing of the first set is different from tooth spacing of the second set. In the incremental adjustment tool, the upper plate can be moved with respect to the middle and lower plates, and the the upper and middle plates can be moved with respect to the lower plate. A differential in tooth spacing causes a differential in relative positions of the first and second objects, potentially by very minute increments.

The novel incremental adjustment tool enables relatively fine adjustments, but without requiring correspondingly small teeth and grooves to receive the teeth. The resultant tool is therefore less expensive to manufacture, and is more robust, compared to a tool having teeth close in size to the magnitude of an intended incremental adjustment.

### BRIEF DESCRIPTION OF THE DRAWINGS

The above and other objects and features of the examples will become apparent and more readily appreciated from the following description of the examples with reference to the following figures, wherein like reference numerals refer to like parts throughout the various figures unless otherwise specified, and wherein:

FIG. 1 illustrates a schematic side view of an incremental adjustment tool according to an example of the disclosure.

FIG. 2 illustrates a schematic side view of the incremental adjustment tool of FIG. 1 with a first object and a second object according to at least one example of the disclosure.

FIGS. 3A, 3B, 3C, 3D, 3D, 3E, 3F, 3G, and 3H schematically illustrate various views of an incremental adjustment tool during the process of manufacture and assembly according to at least one example of the disclosure.

FIG. 4 schematically illustrates a close up side view of a milled material for use in the incremental adjustment tool of FIG. 3C according to an example of the disclosure.

FIG. 5 schematically illustrates an exploded assembly view of the incremental adjustment tool prior to completing assembly according to an example of the disclosure.

FIGS. 6, 7, and 8 schematically illustrate several views of the incremental adjustment tool in various stages of assembly according to at least one further aspect of the examples.

FIG. 9 is a schematic side view of an incremental adjustment tool, according to at least one aspect of the disclosure.

FIG. 10 is a schematic side view of an incremental adjustment tool, according to at least one further aspect of the disclosure.

FIG. 11 is a schematic side detail view of an element of an incremental adjustment tool, according to still another aspect of the disclosure.

FIG. 12 is a schematic side detail view of still another element of an incremental adjustment tool, according to at least one further aspect of the disclosure.

### DETAILED DESCRIPTION

Implementations of the present disclosure are described more fully hereinafter with reference to the accompanying drawings, in which examples of the inventive concept are shown. In the drawings, the size and relative sizes of layers and regions may be exaggerated for clarity. Like numbers refer to like elements throughout. The examples can, however, be embodied in many different forms and should not be construed as limited to the examples set forth herein. Rather, these examples are provided so that this disclosure will be thorough and complete, and will fully convey the scope of the inventive concept to those skilled in the art. The scope of the examples is therefore defined by the appended claims. The following examples are discussed, for simplicity, with regard to the terminology and structure of a measurement device. However, the examples to be discussed next are not limited to these systems but can be applied to other devices that can not only measure but can move a first device in relation to a second device, or datum point, and which device can include at least two ranges of measurements and/or movements, and which can be summed in different ways.

Reference throughout the specification to “one example” or “an example” means that a particular feature, structure, or characteristic described in connection with an example is included in at least one example of the examples. Thus, the appearance of the phrases “in one example” on “in an example” in various places throughout the specification is not necessarily referring to the same example. Further, the particular feature, structures, or characteristics can be combined in any suitable manner in one or more examples.

According to examples, the problems described above can be addressed by, for example, an incremental adjustment tool that comprises three plates, with two sets of teeth and their respective spacings. According to an example, an incremental adjustment tool according to aspects of the examples can be placed between two objects. It is desired to move the first object with respect to the second object. The three plates comprise an upper plate, middle plate, and lower plate. The upper plate has a set of teeth with a first substantially constant spacing between them that interface with a similar set of teeth of the first substantially constant spacing on the middle plate. On an opposite surface of the middle plate there is a second set of teeth with a second substantially constant spacing between them, that interface with a similar set of teeth of the second substantially constant spacing on a lower plate. In the incremental adjustment tool, the upper plate is moved with respect to the middle and lower plates. The upper and middle plates can be moved with respect to the lower plate. By this, therefore, adjustments of lateral displacement between a first object attached to the upper plate and a second object attached to the lower plate can be achieved. Because of a differential in tooth spacings of the two sets of teeth, a differential in a new relative position of the two objects ensues after the plates have been moved as described.

The following is a list of the elements of the figures in numerical order:

100 Incremental Adjustment Tool
102 First Teeth of the Upper Plate
103 First Spacing, of the First Teeth
104 Second Teeth of the Middle Plate
105 Second Spacing, of the Second Teeth
106 Third Teeth of the Middle Plate
107 Third Spacing, of the Third Teeth
108 Fourth Teeth of the Lower Plate
109 Fourth Spacing, of the Fourth Teeth
110 Upper Plate (or First Plate)
112 Upper Surface of the Upper Plate
114 Lower Surface of the Upper Plate
120 Middle Plate (or Second Plate)
122 Upper Surface of the Middle Plate
124 Lower Surface of the Middle Plate
130 Lower Plate (or Third Plate)
132 Upper Surface of the Middle Plate
134 Lower Surface of the Middle Plate
202 First Object
204 Second Object
300 Milled Material
302 First Side Milled Material
304 Second Side Milled Material
306 First Channel
308 Second Channel
310 Assembly Hole
502 Assembly Bolt
504 Assembly Nut
602 Knob Assembly Bolt
604 Assembly Base
606 Threaded Receptacle
608 Lower Bolts
610 Upper Bolts
612 Arrow
614 Arrow

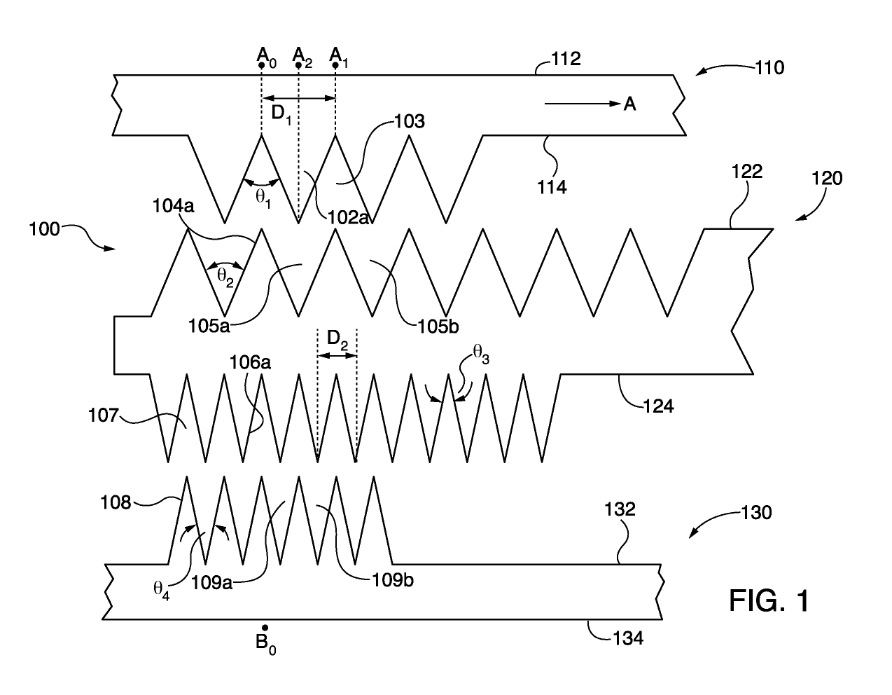

FIG. 1 illustrates incremental adjustment tool 100 according to an example of the novel concept. Incremental adjustment tool 100 comprises upper plate 110, middle plate 120, and lower plate 130.

Upper plate 110 comprises substantially planar upper surface upper plate 112, lower surface upper plate 114, first teeth upper plate 102, and first spacing upper plate 103. First teeth upper plate 102 and first spacing upper plate 103 are located on lower surface upper plate 114. Middle plate 120 comprises upper surface middle plate 122, lower surface middle plate 124, second teeth middle plate 104, second spacing middle plate 105, third teeth middle plate 106, and third spacing middle plate 107. Second teeth middle plate 104 and Second spacing middle plate 105 are located on upper surface middle plate 122. Third teeth middle plate 106 and third spacing middle plate 107 are located on lower surface middle plate 124. Lower plate 130 comprises upper surface lower plate 132, fourth teeth lower plate 108, fourth spacing lower plate 109, and lower surface lower plate 134. fourth teeth lower plate 108 and fourth spacing lower plate 109 are located on upper surface lower plate 132.

According to aspects of the examples, first teeth upper plate 102 and first spacing upper plate 103 oppose second teeth middle plate 104 and second spacing middle plate 105. That is, first teeth upper plate 102 are positioned to interface and substantially fit into second spacings middle plate 105, and second teeth middle plate 104 are positioned to interface and substantially fit into first spacings upper plate 103. Those of skill in the art can therefore appreciate that the first and second teeth and spacings of the upper and middle plates are substantially similar in terms of size, spacing, pitch, and so on. According to further aspects of the examples, however, it can be the case that first teeth upper plate 102 can be of a different size than second teeth middle plate 104 (and the same for first spacings upper plate 103 and second spacings middle plate 105), and the principles of operation of incremental adjustment tool 100 according to aspects of the examples, as described below, would still follow.

According to aspects of the examples, third teeth middle plate 106 and third spacing middle plate 107 oppose fourth teeth lower plate 108 and fourth teeth lower plate 109. That is, third teeth middle plate 106 are positioned to interface and substantially fit into fourth spacings lower plate 109, and fourth teeth lower plate 108 are positioned to interface and substantially fit into third spacings middle plate 107. Those of skill in the art can therefore appreciate that the third and fourth teeth and spacings of the middle and lower plates are substantially similar in terms of size, spacing, pitch, and so on. According to further aspects of the examples, however, it can be the case that third teeth middle plate 106 can be of a different size than fourth teeth lower plate 108 (and the same for third spacings middle plate 107 and fourth spacings lower plate 109), and the principles of operation of incremental adjustment tool 100 according to aspects of the examples, as described below, would still follow.

Further shown in FIG. 1 are several angles, θ₁, θ₂, θ₃, θ₄. These describe the angle between first teeth upper plate 102 (θ₁), the angle between second teeth middle plate 104 (θ₂), the angle between third teeth middle plate 106 (θ₃), and the angle between fourth teeth middle plate 108 (θ₄). According to aspects of the example, as described above, the angles between first teeth upper plate 102 θ₁, and those of second teeth middle plate 104 θ₂, are substantially similar, and can be about 90°. According to further examples, θ₁ and θ₂ can be between about 60° to about 120°. According to an example, as described above, the angles between third teeth middle plate 106 θ₃, and those of fourth teeth lower plate 108 θ₄, are substantially similar, and can be about 90°. According to further examples, θ₃ and θ₄ can be between about 60° to about 120°.

As can be further appreciated by those of skill in the art, for purposes of this discussion, one plate has been designated upper, one plate middle, and one plate lower. It will be considered to be within aspects of the examples, that no particular physical orientation is limiting to incremental adjustment tool 100, and that what is considered lower in the descriptions below, could be upper in a different use, or could be designated first, second, or third in another use, if incremental adjustment tool 100 were to be placed on its side, or any other orientation wherein upper and middle have little or no meaning. Thus, it is only for the purposes of this discussion that the plates have been designated upper, middle, and lower, and the same are not to be construed in any manner as limiting incremental adjustment tool 100 to any orientation. The same applies to the description and location of coarse and fine teeth.

According to further aspects of the examples, although incremental adjustment tool 100 has been shown to have three plates, it can be increased to 4, 5, 6 or any number of plates, and still achieve the functions of the aspects of the examples that includes at least being able to accurately, repeatedly, and with precision place a first object at some known, pre-determinable position relative to a second object. It can be further appreciated by those of skill in the art, that the first and second objects can be “datum” points with respect to an object or some surface.

Still further according to aspects of the examples, while all of the plate can be made of the same material, that need not necessarily be the case. According to further aspects of the examples, the materials used can be selected based on desired tolerances and durability, dependent upon usage, as those of skill in the art can appreciate. By way of non-limiting examples only, for purposes of illustration, a first material could be acrylonitrile butadiene styrene (ABS) plastics, the properties of which are well known to those of skill in the art. A second material that can be used to fabricate one or more of the plates are aluminum alloys, which will have different properties than that of ABS plastic, as can be appreciated by those of skill in the art.

As described above, upper plate 110 comprises substantially planar upper surface 112; however, that need not necessarily be the case; for purposes of this discussion, however, a flat upper surface makes it easier to illustrate the different aspects of the examples. Furthermore, it can be appreciated by those of skill in the art that the term “coarse” and “fine” are relative terms; e.g., what is “coarse” for a first application could be “fine” for a second application. In building a house, for example, most measurements do not exceed in granularity an eighth, or perhaps a sixteenth of inch ( 1/16=0.0625 inches, or 6.25×10⁻² inches); however, in manufacturing microprocessors, the dies needed to etch the transistors into the silicon wafers using photolithography processes must be able to be resolved in the order of 45 nanometers; a nanometer is 1×10⁻⁹ meters, or 3.93700787×10⁻⁸ inches. Thus machines used to attach very fine diameter gold leads to circuits made such manner could be required to move and locate the gold leads in resolutions ranging from tens of nanometers to hundreds of nanometers.

As described above, middle plate 120 comprises upper surface 122 with second teeth middle plate 104 that are in substantial alignment with first teeth upper plate 102, and are substantially similar in size (height, depth, angle, among other measurements), to first teeth upper plate 102. Middle plate 120 further comprises, according to an example, a second set of teeth, third teeth middle plate 106, that are located on lower surface middle plate 124 that is opposite to that of second teeth middle plate 104 and upper surface middle plate 120. Those of skill in the art can readily appreciate that it does not particularly matter in the different aspects of the examples which is the lower plate, and which is the upper plate; these designations have been made solely for the purposes of this discussion, and should not be taken in a limiting manner. Fourth teeth lower plate 108 are substantially similar in terms of all measurements as third teeth middle plate 106, and are in substantial alignment with third teeth middle plate 106, similar to the arrangement between second teeth middle plate 104 on upper surface middle plate 122, and first teeth upper plate 102 on lower surface upper plate 114.

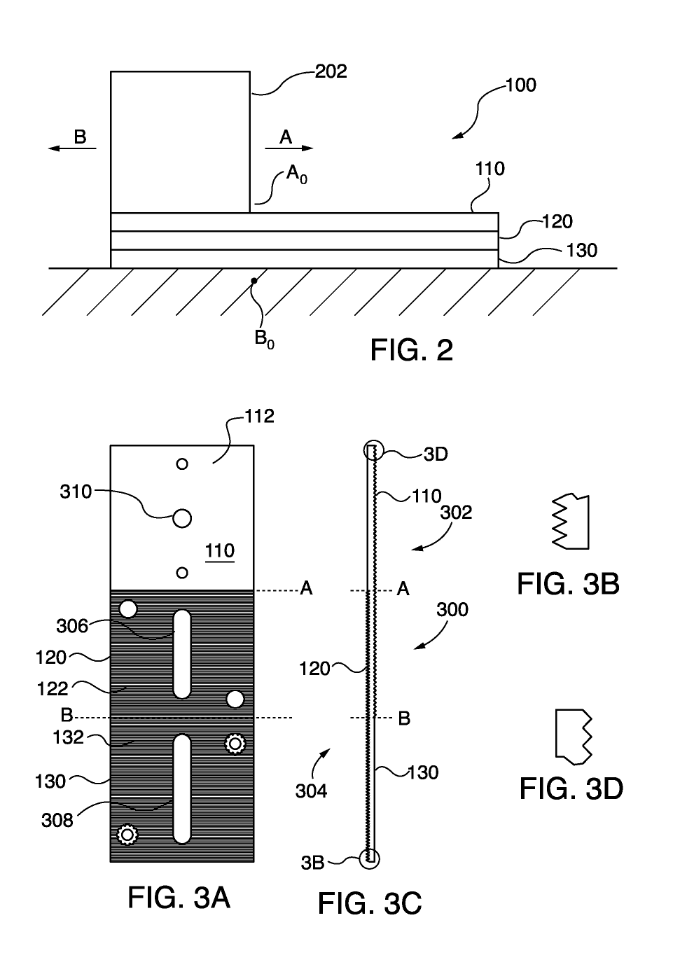

Further shown in FIG. 1 are several datum points: A₀, A₁, A₂, and B₀. A₀ marks a point of reference on upper plate 110; it could be a corner of some first object, or any other reference point that is being used to measure a distance of movement between the first object, i.e., the point of reference of upper plate 110, and that of B₀, which is a point of reference on lower plate 130. FIG. 2 illustrates a side view of the incremental adjuster device of FIG. 1 with a first object and a second object according to an example. According to an aspect of the examples, one use of incremental adjustment tool 100 is to move a first object in reference to a second object or location; data point A₀ represents a point of reference for the first object, and B₀ the point of reference to the second object or location.

According to a further aspect of the examples, the distance between coarse teeth on both the upper and middle plates is defined as D₁. The distance between the fine teeth on both the middle and lower plates is defined as D₂. In FIG. 1, D₁ is shown as being twice the length of D₂; this is only done for purposes of illustration and discussion, as discussed in greater detail below. Several examples of movement of the plates will now be discussed to illustrate the various aspects of the examples.

A first movement of upper plate 110 can be made in regard to middle plate 120 and lower plate 130; that is if middle plate 120 and lower plate 130 are not moved, and only upper plate 110 is moved, and moved to the right, in the direction of arrow A, then for each movement of a first first tooth upper plate 102a at first second spacing middle plate 105a of middle plate 120 to second second spacing middle plate 105b of middle plate 120, upper plate 110 moves a distance of D₁ to the right, or A₀ moves to datum point A₁ by a distance of D₁. Thus, for each coarse tooth-to-coarse spacing movement, datum point A₀ moves a distance of D₁. The coarse tooth-to-coarse spacing movement can be made to the left or right. According to further aspects of the examples, a movement to the right can correspond to a positive movement (+), and a movement to the left can correspond to a negative movement (−). As those of skill in the art can appreciate, such designation is arbitrary, but it is desired to have a consistent frame of reference in certain applications that incremental adjustment tool 100 will be used in.

A second movement of upper plate 110 and middle plate 120 can be made in regard to lower plate 130; that is if upper plate 110 and middle plate 120 are moved together with respect to lower plate 130, which is not moved, and only upper plate 110 and middle plate 120 are moved together and to the right, in the direction of arrow A, then for each movement of a first third tooth middle plate 106a at first fourth spacing lower plate 109a of lower plate 130 to a second fourth spacing lower plate 109b of lower plate 130, upper plate 110 moves a distance of D₂ to the right, or A₀ moves to datum point A₂ by a distance of D₂ (the spacing between the fine teeth of the middle and lower plates). Thus, for each fine tooth-to-fine spacing movement, datum point A₀ moves a distance of D₂. The fine tooth-to-fine spacing movement can be made to the left or right.

As should be apparent to those of skill in the art, the movements were described above as if lower plate 130 were fixed in place; those of skill in the art can appreciate that lower plate 130 could be moved with respect to middle and upper plates 120, 110, and lower and middle plates 130, 120 can be moved with respect to upper plate 110, and the same lengths or distances of movements between the respective datum points can be achieved.

As those of skill in the art can appreciate, any combination of coarse and fine teeth-to-spacing movements can be made, in any combination. Just by way of non-limiting example, and for purposes of this discussion only, a few examples will be described.

Datum point A₀ can be moved n×D₁ to the right or left with respect to datum point B₀, and datum point A₀ can be move m×D₂ to the right or left with respect to datum point B₀. Any combination of movements can be made; that is, a first movement of—

3×D_1+2×D_2 (1),

can be made, or a second movement of—

1×D₁−1×D₂ (2)

is also possible, among any one of a near limitless plurality of other combinations. If, by way of example only, D₁ is set to 0.064″ and D₂ is set to 0.060″, then Equations 1 and 2 would result in the following respective lengths or distances of movements:

3×0.064″+2×0.060″=0.312″ (3)

and

1×0.064−1×0.06=0.004″ (4)

Equation (4) illustrates an aspect of the examples, which, by choosing D₁ and D₂ to be about the same, but not exactly the same, a distance resolution can be achieved that is the difference between the two. Thus, by making both coarse and fine teeth to be relatively large, yet making the difference between the two relatively small, very fine adjustments in distance movement can be achieved.

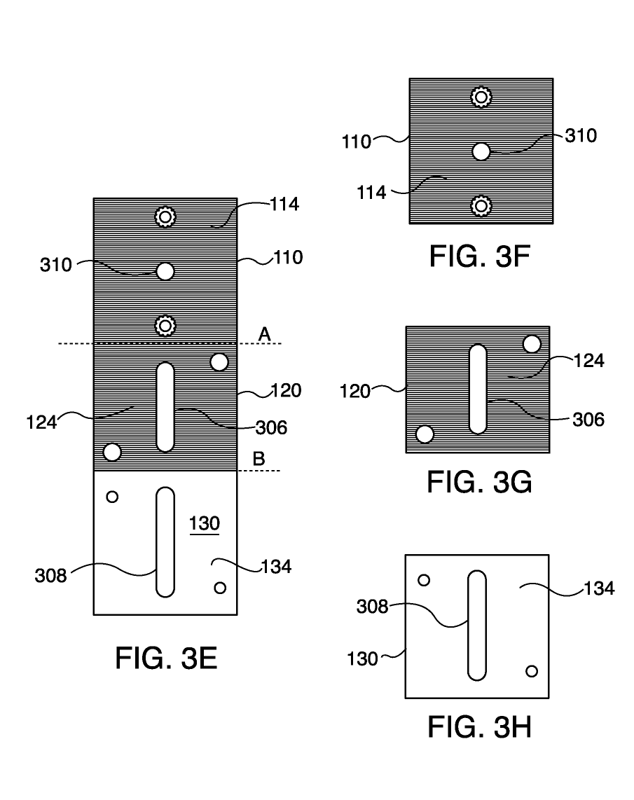

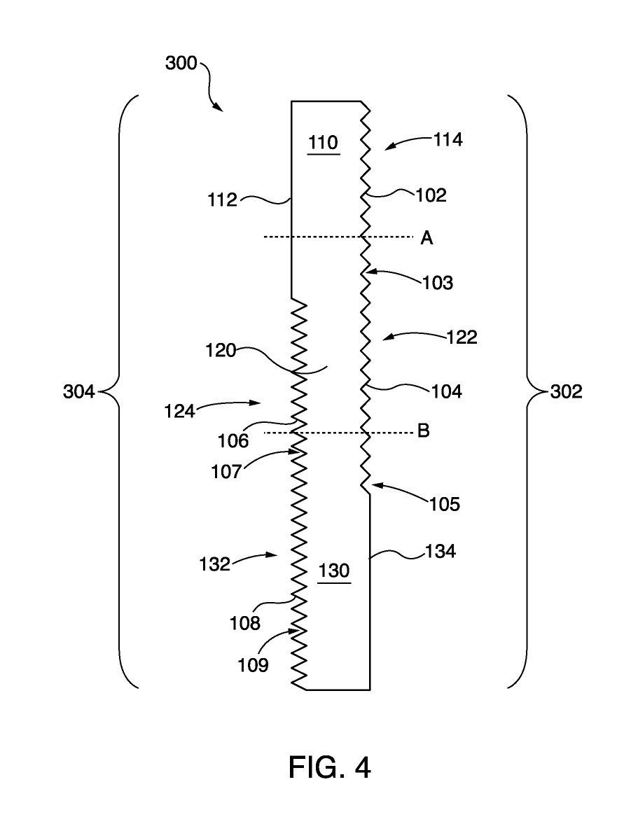

FIGS. 3A, 3B, 3C, 3D, 3D, 3E, 3F, 3G, and 3H illustrate various views of incremental adjustment tool 100 during the process of manufacture and assembly according to an example, and FIG. 4 illustrates a close up side view of milled material 300 for use in assembling incremental adjustment tool 100 according to an example. FIG. 3C illustrates a side view of milled material 300 according to an example. In FIG. 3C, a substantially flat, planar piece of material, of the dimensions referenced in FIGS. 3A, 3B, 3C, 3D, 3D, 3E, 3F, 3G, and 3H, is milled such that first side 302 has on it first teeth 102, first spacings 103, second teeth 104, second spacings 105, and what will become lower surface lower plate 134. This is shown in greater detail in FIG. 4. Also shown in greater detail is second side 304 of milled material 300 of FIG. 3C, that shows what will become upper surface upper plate 112, third teeth 106, third spacings 107, fourth teeth 108, and fourth spacings 109. As can be appreciated by those of skill in the art, the milling of a piece of material as shown in the collective illustrations of FIGS. 3A, 3B, 3C, 3D, 3D, 3E, 3F, 3G, and 3H means that a complete assembly of incremental adjustment tool 100 can be made from a single piece of material with relatively few steps. That is, according to an example, a piece of appropriate material that is, by way of example 5 feet or 10 feet in length by 5.75 inches in height, can be milled on both sides as shown in the collective Figures, and then the appropriately sized widths cut, creating a plurality of pieces of milled material 300 according to an example. Each milled material 300 can then be cut along lines A and B, creating upper plate 110, middle plate 120, and lower plate 130 as shown in FIGS. 3F, 3G, and 3H. As those of skill in the art can appreciate, the appropriate assembly holes and channel 306, 308, and 310 can be drilled/formed pre- or post-milling. Typically, however, in order to make the manufacturing process as efficient as possible, the drilling/forming of holes and channels can be done prior to separation of the individual pieces of milled material 300.

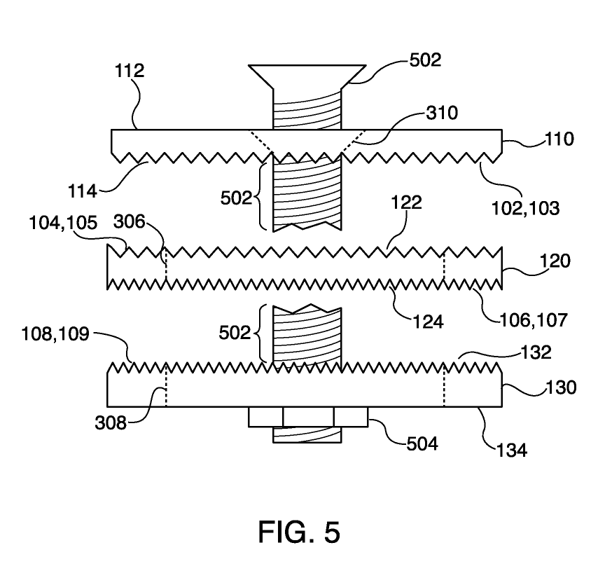

FIG. 5 illustrates an exploded assembly view of incremental adjustment tool 100 prior to completing assembly according to an example. The assembly of FIG. 5 illustrates a partially or pre-assembled state of upper plate 110, middle plate 120 and lower plate 130 as cut from milled material 300. The assembly of FIG. 5 illustrates how the components 110, 120, and 130 can be placed together according to one non-limiting manufacturing example. Assembly bolt 502 can be a flat head bolt of appropriate diameter to fit substantially closely within assembly hole 310. The flat head design of assembly bolt 502 can be such that the flat head of assembly bolt 502 is flush with upper surface upper plate 112. Assembly bolt 502 can be just long enough to join the three plates 110, 120, 130 together along with assembly nut 504. In use, assembly bolt 504 can be loosened, but not dissembled, and upper plate 110 can be moved in regard to middle and lower plates 120, 130 to obtain one or more lengths of distance D1, or, upper and middle plates 110, 120 can be moved in regard to lower plate 130 to obtain one or more lengths of distance D2, as described in greater detail above.

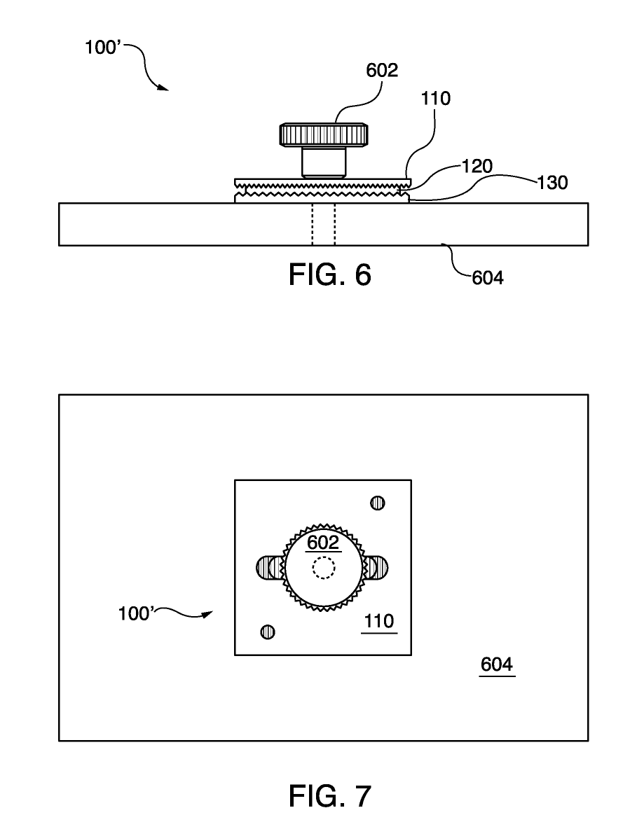

FIGS. 6, 7, and 8 illustrate several views of incremental adjustment tool 100′ in various stages of assembly according to a further aspect of the examples.

Incremental adjustment tool 100′ is substantially similar to that of tool 100, in that it has substantially similar components (plates 110, 120, 130, teeth 102, 104, 106, 108, spacings 103, 105, 107, 109, and surfaces 112, 114, 122, 124, 132, 134, and other components not mentioned), but is different in that as an assembly it now includes knob assembly bolt 602, assembly base 604, and threaded receptacle 606, as will now be described in greater detail.

In FIG. 5, in the incremental adjustment tool 100, the first set of teeth 102 extend from one side of the first plate 110 to an opposed side of the first plate 110. Also, the second set of teeth 104 extend from one side of the second plate 120 to an opposed side of the second plate 120. Further, the third set of teeth 106 extend from the one side of the second plate 120 to the opposed side of the second plate 120. Still further, the fourth set of teeth 108 extend from one side of the third plate 130 to an opposed side of the third plate 130.

As seen in the diagrammatic detail view of FIG. 1, in the incremental adjustment tool 100, the first set of teeth 102 extend only partly from one side of the first plate 110 to an opposed side of the first plate 110. Additionally, the second set of teeth 104 extend only partly from one side of the second plate 120 to an opposed side of the second plate 120. Further, the third set of teeth 106 extend only partly from the one side of the second plate 120 to the opposed side of the second plate 120. Still further, the fourth set of teeth 108 extend only partly from one side of the third plate 130 to an opposed side of the third plate 130.

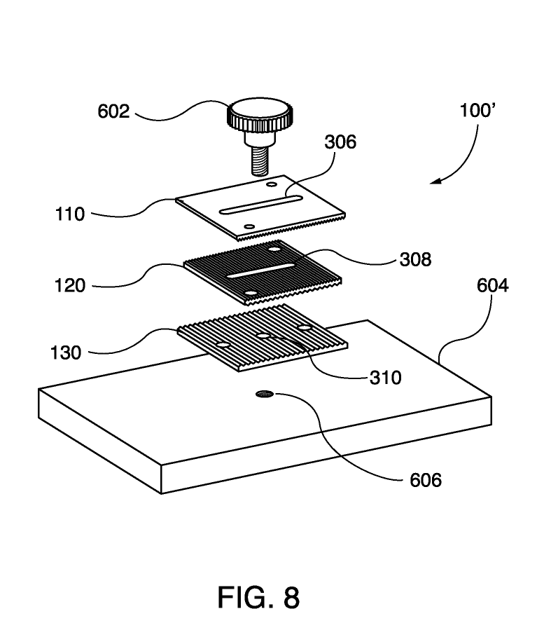

Incremental adjustment tool 100′ is provided as a non-limiting example of how such an adjustment tool assembly according to aspects of the examples can be assembled and used to provide precise, fine, and repeatable movements between two objects. A first object can be attached to upper plate 110 using the mounting holes as shown in FIGS. 7 and 8, and movement can be made using incremental adjustment tool 100′ between the first object (not shown) and the assembly base by loosening knob assembly bolt 602, lifting the plates 110, 120, as described above in order to get the desired distance movement, and then retightened. The knob assembly bolt 602 is longer than combined thicknesses of the first plate 110 and the second plate 120. As illustrated, the knob assembly bolt (602) is longer than combined thicknesses of the first plate 110, the second plate 120, and the third plate 130.

Knob assembly bolt 602 thus provides at a minimum a fastener configured to releasably unite the first plate 110 and the second plate 120. As illustrated in FIG. 8, the knob assembly bolt 602 is configured to releasably unite the second plate 120 and the third plate 130 as well as the first plate 110. Assembly base 604 contains threaded receptacle 606 that includes a thread that substantially mates with that of the thread of knob assembly bolt 602, in a manner known to those of skill in the art. Upper plate 110 includes first channel 306, and middle plate 120 contains second channel 308 to effect the movement between the plates to obtain the desired distance in substantially the same manner as described above. First channel 306 in the first plate 110 is configured to pass the knob assembly bolt 602 therethrough. Second channel 308 in the second plate 120 is configured to pass knob assembly bolt 602 therethrough.

According to further aspects of the examples, assembly base 604 can be attached to some other object to effect movement between the first object and the other object.

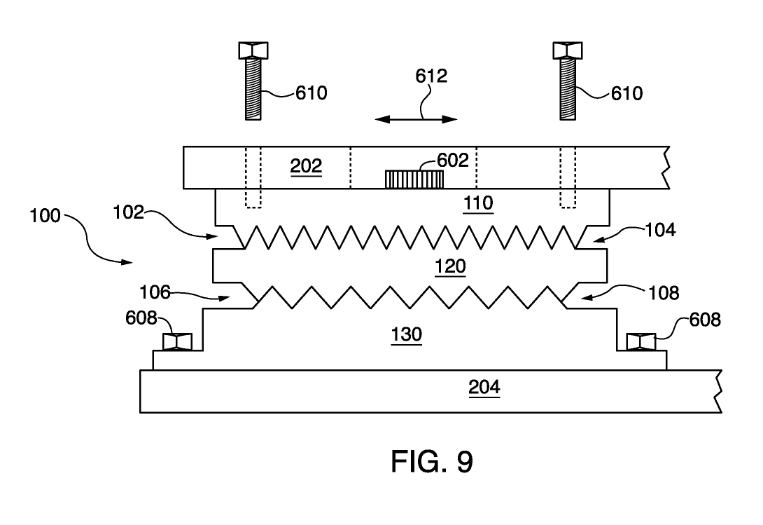

FIG. 9 shows a first object 202 and a second object 204 assembled with the incremental adjustment tool 100 intervening therebetween. As seen in FIGS. 1, 4-6, and 9, in the incremental adjustment tool 100, teeth of the first set of teeth 102 and the second set of teeth 104 are wedge shaped. Additionally, in the incremental adjustment tool 100, teeth of the third set of teeth 106 and the fourth set of teeth 108 are wedge shaped. The wedge shape is seen in side profile. Other tooth configurations could be utilized, such as conical or pyramidal (not shown). In FIG. 9, direction of adjustment of position of the first object 202 relative to the second object 204 is indicated by an arrow 612, which indicates lateral movement of the first object 202 in a direction parallel to the upper surface of the second object 204.

In FIG. 9, the incremental adjustment tool 100 is fixed by bolts 608 to the second object 204, and to the first object 202 by bolts 610. In the incremental adjustment tool 100, bolts 610 comprise a first fastener arrangement releasably coupling the incremental adjustment tool 100 to the first object 202. Similarly, in the incremental adjustment tool 100, bolts 608 comprise a second fastener arrangement releasably coupling the incremental adjustment tool 100 to the second object 204.

As seen in FIGS. 1, 2, 3C, 4, 5, 6, 8, and 9, in the incremental adjustment tool 100, the upper surface 112 of the first plate 110 is generally parallel to the lower surface 114 of the first plate 110. As employed herein, although the lower surface 114 is not planar as is the upper surface 112, similar elements of lower surface 114, such as all of the crests of the teeth of the first set of teeth 102, or all of the valleys of the teeth of the first set of teeth 102, collectively define a plane which is parallel to the planar upper surface 112. The term “generally similar”, as applied to parallelism between surfaces of first plate 110, second plate 120, and third plate 130, will apply as defined above.

Similarly, and also referring to FIGS. 1, 2, 3C, 4, 8, and 9, but particularly to FIGS. 5 and 6, in the incremental adjustment tool 100, the upper surface 122 of the second plate 120 is generally parallel to the lower surface 124 of the second plate 120. Continuing in the same vein, the upper surface 132 of the third plate 130 is generally parallel to the lower surface 134 of the third plate 120.

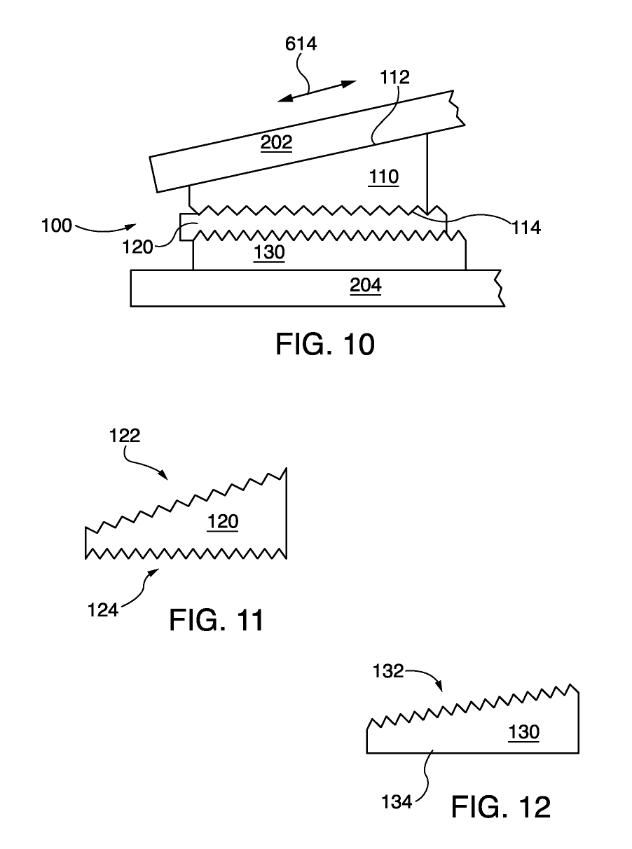

FIG. 10 shows an implementation of the incremental adjustment tool 100 wherein the upper surface 122 of the first plate 110 is not parallel to the lower surface 124 of the first plate 110. This implementation accommodates lateral adjustment of the first object 202 along the second object 204 even where respective facing surfaces of the first object 202 and of the second object 204 are not parallel to one another. This non-parallel lateral adjustment is indicated by an arrow 614.

Referring to FIG. 11, accommodation of non-parallel surfaces of the first object 202 and the second object 204, both shown in FIG. 10, may be accomplished by geometry of the second plate 120. In the incremental adjustment tool 100, the upper surface 122 of the second plate 120 is not parallel to the lower surface 124 of the second plate 120.

Referring to FIG. 12, accommodation of non-parallel surfaces of the first object 202 and the second object 204 may be accomplished by geometry of the third plate 130. In the incremental adjustment tool 100, the upper surface 132 of the third plate 130 is not parallel to the lower surface 134 of the third plate 120.

As discussed in regard to FIGS. 1, 2, 3A, 3B, 3C, 3D, 3D, 3E, 3F, 3G, 3H, 4, 5, 6, 7, and 8 reference is made to several dimensions, including several radii, angles, height, among others. Those of skill in the art can appreciate that although examples of dimensions are provided, these should not be taken in a limiting manner; that is, the aspects of the examples are not to be construed as defined or limited by the specific example of the dimensions shown and discussed, but instead are provided merely for illustrating an example of what a device that incorporates the aspects of the examples could, in a non-limiting manner, look like. Furthermore, as those of skill in the art can appreciate, since the aspects of the examples are directed towards a physical object, with dimensional characteristics, all of the parts will have various dimensions, some of which have not been shown in fulfillment of the dual purposes of clarity and brevity. According to still further aspects of the examples, some of these objects will have dimensional characteristics that lend themselves to aesthetic aspects; in fulfillment of the dual purposes of clarity and brevity, dimensions in this regard have also been omitted. Therefore, as the aspects of the examples are directed towards an incremental adjustment tool used for moving one object in regard to another, it is to be understood that the dimensions of the different objects, some dimensions shown, some dimensions not shown, will be understood by those of skill in the art.

The disclosed examples provide an incremental adjustment tool. It should be understood that this description is not intended to limit the examples. On the contrary, the examples are intended to cover alternatives, modifications, and equivalents, which are included in the spirit and scope of the examples as defined by the appended claims. Further, in the detailed description of the examples, numerous specific details are set forth to provide a comprehensive understanding of the claimed examples. However, one skilled in the art would understand that various examples can be practiced without such specific details.

Although the features and elements of aspects of the examples are described being in particular combinations, each feature or element can be used alone, without the other features and elements of the examples, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and can include other examples that occur to those skilled in the art. Such other examples are intended to be within the scope of the claims.

The above-described examples are intended to be illustrative in all respects, rather than restrictive, of the examples. Thus the examples are capable of many variations in detailed implementation that can be derived from the description contained herein by a person skilled in the art. No element, act, or instruction used in the description of the present application should be construed as critical or essential to the examples unless explicitly described as such. Also, as used herein, the article “a” is intended to include both one item and more than one item.

All United States patents and applications, foreign patents, and publications discussed above are hereby incorporated herein by reference in their entireties.

I claim:

1. An incremental adjustment tool (100) for adjusting relative positions of a first object and a second object, comprising:
a first plate (110) including an upper surface (112) and an opposed lower surface (114), a first set of teeth (102) on the lower surface (114), and first spacings (103) between adjacent ones of the first set of teeth (102) on the lower surface (114);
a second plate (120) including an upper surface (122) and an opposed lower surface (124), a second set of teeth (104) on the upper surface (122) of the second plate (120) and second spacings (105) between adjacent ones of the second set of teeth (104) on the lower surface (124), the second set of teeth (104) and second spacings (105) substantially similar to the first set of teeth (102) and first spacings (103) on the lower surface (114) of the first plate (110), wherein the first set of teeth (102) and the second set of teeth (104) are configured and dimensioned to mesh with each other, and a third set of teeth (106) and third spacings (107) between adjacent ones of the third set of teeth (106) on the lower surface 124 of the second plate (120), the third set of teeth (106) and third spacings (107) different than the first set of teeth (102), second set of teeth (104) and spacings (103, 105); and
a third plate (130) including an upper surface (132) and an opposed lower surface (134), a fourth set of teeth (108) and fourth spacings (109) substantially similar to the third set of teeth (106) and third spacings (107) of the second plate (120), wherein the third set of teeth (106) and third spacings (107) and fourth set of teeth (108) and fourth spacings (109) are configured and dimensioned to mesh with each other.

2. The incremental adjustment tool (100) of claim 1, further comprising a knob assembly bolt (602) configured to releasably unite the first plate (110) and the second plate (120).

3. The incremental adjustment tool (100) of claim 2, wherein the fastener (602) is longer than combined thicknesses of the first plate (110) and the second plate (120).

4. The incremental adjustment tool (100) of claim 2, further comprising a first channel (306) in the first plate (110) configured to pass the knob assembly bolt (602) therethrough.

5. The incremental adjustment tool (100) of claim 4, wherein the knob assembly bolt (602) is longer than combined thicknesses of the first plate (110), the second plate (120), and the third plate (130).

6. The incremental adjustment tool (100) of claim 2, wherein the knob assembly bolt (602) is configured to releasably unite the second plate (120) and the third plate (130).

7. The incremental adjustment tool (100) of claim 6, further comprising a second channel (308) in the second plate (120), the second channel (308) configured to pass the knob assembly bolt (602) therethrough.

8. The incremental adjustment tool (100) of claim 1, wherein teeth of the first set of teeth (102) and the second set of teeth (104) are wedge shaped.

9. The incremental adjustment tool (100) of claim 1, wherein teeth of the third set of teeth (106) and the fourth set of teeth (108) are wedge shaped.

10. The incremental adjustment tool (100) of claim 1, further comprising a first fastener arrangement releasably coupling the incremental adjustment tool (100) to the first object (202).

11. The incremental adjustment tool (100) of claim 1, further comprising a second fastener arrangement releasably coupling the incremental adjustment tool (100) to the second object (204).

12. The incremental adjustment tool (100) of claim 1, wherein the first set of teeth (102) extend from one side of the first plate (110) to an opposed side of the first plate (110).

13. The incremental adjustment tool (100) of claim 1, wherein the first set of teeth (102) extend only partly from one side of the first plate (110) to an opposed side of the first plate (110).

14. The incremental adjustment tool (100) of claim 1, wherein the upper surface (112) of the first plate (110) is generally parallel to the lower surface (114) of the first plate (110).

15. The incremental adjustment tool (100) of claim 1, wherein the upper surface (112) of the first plate (110) is not parallel to the lower surface (114) of the first plate (110).

16. The incremental adjustment tool (100) of claim 1, wherein the upper surface (122) of the second plate (120) is generally parallel to the lower surface (124) of the second plate (120).

17. The incremental adjustment tool (100) of claim 1, wherein the upper surface (122) of the second plate (120) is not parallel to the lower surface (124) of the second plate (120).

18. The incremental adjustment tool (100) of claim 1, wherein the upper surface (132) of the third plate (130) is generally parallel to the lower surface (134) of the third plate (120).

19. The incremental adjustment tool (100) of claim 1, wherein the upper surface (132) of the third plate (130) is not parallel to the lower surface (134) of the third plate (120).
